(19) United States
(12) Patent Application Publication
(10) Pub. No.: US 2021/0396373 A1
(43) Pub. Date: Dec. 23, 2021

(54) PEDESTRIAN COMMUNICATION VEHICLE FOG LAMP

(71) Applicant: Myotek Industries, Farmington Hills, MI (US)

(72) Inventors: Robert Herbert Miller, Canton, MI (US); Erik Lee Measel, Oxford, MI (US)

(21) Appl. No.: 17/351,481

(22) Filed: Jun. 18, 2021

Related U.S. Application Data
(60) Provisional application No. 63/040,806, filed on Jun. 18, 2020.

(51) Int. Cl. F21S 43/50

(52) U.S. Cl. CPC F21S 43/50; F21W 2102/30

(57) ABSTRACT

A vehicle mounted pedestrian communication lamp including a housing defining an inner package space for receiving a main illuminating component and at least one secondary component for providing variable depictions based upon a processor input to the secondary element. The secondary element further includes at least one individual matrix display containing a plurality of illuminating elements. The illuminating elements each further include any of LED, TFFL, transparent LCD or OLED displays. The individual matrix display further includes either of a rigid or flexible display. The flexible display may also include a thin film transistor (TFT) display. Other features includes a pair of secondary illuminating components provided on either side of the main illuminating component. The main illuminating component can also be provided as a fog lamp. The processor communicates with an external input via any of Bluetooth or Near Field Communication protocols.

### CROSS REFERENCE TO RELATED APPLICATIONS

The present application claims the priority of U.S. Ser. No. 63/040,806 filed Jun. 18, 2020.

### FIELD OF THE INVENTION

The present invention relates generally to vehicle fog lamp designs. More specifically, the present invention discloses a fog lamp incorporating an illuminating matrix (incorporating any of LED, OLED, TFT, TFFL or LCD elements) and which can be integrated into any rigid or flexible substrate displays configured behind a protective outer lens and such as which can be mounted either aside the main lamp or in any configuration with any shape of matrix possible. Aside from the subset display, additional features can include the provision of a transparent display located on either side of the outer lens which is capable of providing successive and alternating representations, such as for viewing by pedestrians in an urban setting, and from either of a manned or autonomous vehicle. The present invention further envisions either or both of direct communication of the vehicle turn signal processor with the fog lamp display as well as providing for any type of Bluetooth or Near Field Communication protocols for instructing a vehicle processor in communication with the fog lamp for instructing nearby pedestrians.

### BACKGROUND OF THE INVENTION

The prior art is documented with numerous examples of vehicle headlamp and fog lamp designs. Among these is the vehicle exterior lamp of US 2011/0169410 to Dassanayake which teaches an array of light emitting diodes (LEDs) with rows and columns and each LED positioned at an intersection thereof. An LED is illuminated by selectively applying a signal to the row and column corresponding to the LED position. A vehicle headlamp lighting system is provided with an array of LEDs with rows and columns, and each LED positioned at a row and column intersection. The lighting system has a control module for selectively illuminating the LEDs by applying a signal to the rows and to the columns corresponding to the location of the LEDs to be illuminated. A vehicle headlamp is provided with an optical structure for reflection and refraction of light and LEDs. Light emitted by the LEDs interacts with the optical structure and exits the headlamp in a generally perpendicular direction to the LED emitted light.

Other examples include CN 1098-1488 which teaches a pedestrian traffic safety early warning device. Road information is collected by sensors, and after the road information is processed by a control module. An LED light-emitting device and a buzzing alarm are instructed to provide road safety early waring information for passing pedestrians. The pedestrian traffic safety early warning device is composed of a power supply module, an LED light-emitting module, a sound early warning module, a protection device, an information collection module and a control module. The power supply module is composed of a solar photovoltaic panel and a lithium ion storage battery such that, when solar energy is sufficient, the solar photovoltaic panel charges the storage battery; and when solar energy is insufficient, electric energy stored by the storage battery provides energy for the system to ensure the normal operation of the system.

### SUMMARY OF THE PRESENT INVENTION

The present invention discloses a vehicle mounted pedestrian communication lamp including a housing defining an inner package space for receiving a main illuminating component and at least one secondary component for providing variable depictions based upon a processor input to the secondary element. The secondary element further includes at least one individual matrix display containing a plurality of illuminating elements.

The illuminating elements each further include any of LED, TFFL, transparent LCD or OLED displays. The individual matrix display further includes either of a rigid or flexible display. The flexible display may also include a thin film transistor (TFT) display.

Other features includes a pair of secondary illuminating components provided on either side of the main illuminating component. The main illuminating component can also be provided as a fog lamp. The processor communicates with an external input via any of Bluetooth or Near Field Communication protocols.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an illustration of a vehicle supported and pedestrian communication lamp presenting a first depiction of the present invention;

FIG. 1A is an exploded view of FIG. 1 and depicting the basic components of the protective outer lens covering the main lamp and either of the rigid or flexible substrate displays configured behind a protective outer lens and such as which can be mounted either aside the main lamp or in any configuration with any shape of matrix possible for providing the customized pedestrian notification representations;

FIG. 2 is a succeeding view to FIG. 1 presenting a second alternate depiction;

FIG. 3 is an illustration of a vehicle lamp according to a further configuration and presenting a given LED illuminated depiction;

FIG. 4 is a succeeding view to FIG. 3 with the lamp depicting a second LED generated representation;

FIG. 5 is a further succeeding view of a lamp design similar to FIG. 3 according to a third varied LED generated depiction;

FIG. 6 provides a fourth LED depiction of the lamp design of FIG. 3; and

FIG. 7 is an illustration similar to FIG. 1 of a further variant of the pedestrian communication fog lamp according to the present invention.

### DETAILED DESCRIPTION OF THE PREFERRED EMBODIMENTS

With reference to the attached illustrations, the present invention discloses a vehicle supported and pedestrian communication lamp, such including but not limited to a fog lamp incorporating an LED matrix and including both rigid and flexible substrate displays configured behind a protective outer lens. Without limitation, the pedestrian communication lamp can be mounted either aside the main lamp or in any configuration with any shape of matrix possible.

As will be further described, and aside from the subset display, additional features can include the provision of a transparent display located on either side of the outer lens which is capable of providing successive and alternating representations, such as provided by an on-board processor component associated with the illuminating output display, and for viewing by pedestrians, typically in an urban setting.

The present invention contemplates application of the pedestrian communication lamp from either of a manned or autonomous vehicle and further envisions, in a most basic functionality, directly communicating the vehicle turn signal processor with the fog lamp display for notifying pedestrians that the vehicle is about to execute a turn. Additional functionality can include the lamp communicating processor interfacing with other inputs which can include those external of the vehicle, such as via any type of Bluetooth or Near Field Communication protocols, for instructing a vehicle processor in communication with the fog lamp for instructing nearby pedestrians.

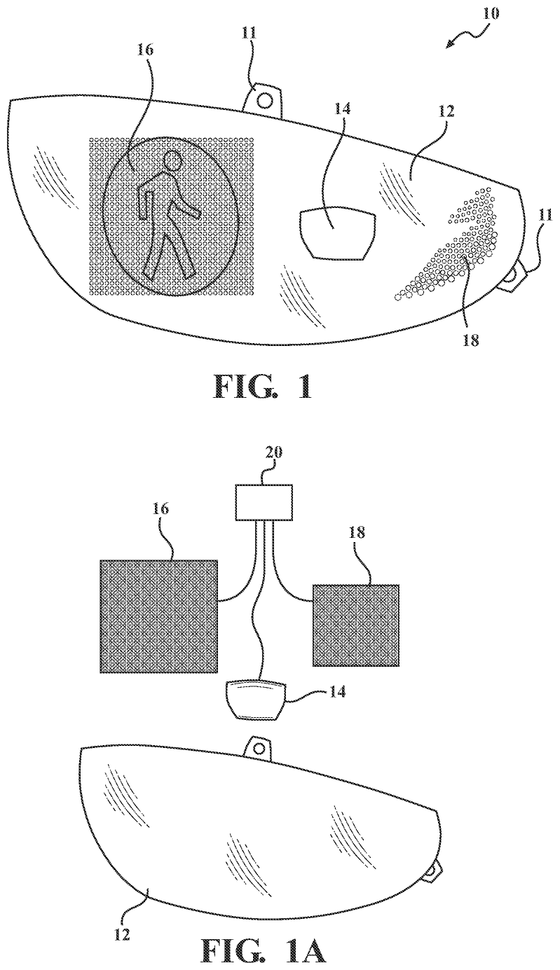

Referring now to each of FIGS. 1 and 1A, an illustration is generally shown at 10 in FIG. 1 of a lamp assembly, such as a fog lamp, according to one non-limiting application of the present invention. As previously described, the lamp includes a three dimensional body conforming to the exterior styling of a given vehicle and for securing the lamp to the vehicle (not shown) at the given location, such as through the use of mounting brackets 11.

As further depicted both in FIG. 1 as well as in the exploded view of FIG. 1A, the forward face of the lamp assembly is covered by an outer lens 12 which shields a main lamp illuminating portion 14 (such as a halogen or other high intensity illuminating source) for providing the primary fog lamp function. Also provided behind the outer lens, and such as to either side of the main illuminating lamp 14, are pair of secondary illuminating elements in the form of either flexible or rigid subset displays 16 and 18, these further capable of providing customized pedestrian notification representations in response to inputs from a processor component 20 which can further illuminate the main lamp 14.

As previously described, the processor 20 can be in turn instructed by other inputs, such as associated with the vehicle turn signal and/or can be separately instructed by such as a Bluetooth or Near Field (NFC) Communication Protocol and from either the vehicle or from an exterior source not limited to a smart street lamp or other traffic communication device which may be located in the vicinity of the vehicle. The housing can also include a plug in attachment or the like (not shown) which receives power from the vehicle to operate the main illuminating lamp 14 as well as the individual LED matrixes 16 and 18 according to the desired inputs from the processor component 20.

As further understood, the subset displays 16 and 18 are envisioned to includes (without limitation) any type of matrix display incorporating pluralities of LED or similar types of illuminating components which can be utilized for providing variable and customized representations based on each of color, pattern and intensity and depending upon the input signals received from the processor component 20. Without limitation, the subset displays 16 and 18 can further include any of thin film transistor (TFT) or organic light emitting (OLED) style displays.

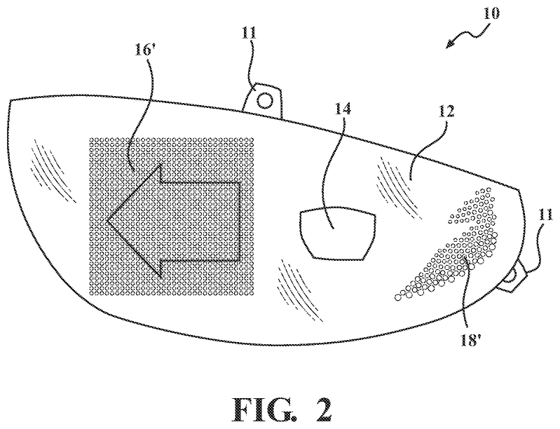

The pedestrian communication fog lamp design provides the advantage of utilizing the existing packaging space of the fog lamp assembly to allow for communication of safety and other information to any pedestrian or driver of another vehicle. This can include such as the representations 16 and 18 of FIG. 1 of a vehicle supported and pedestrian communication lamp or those further shown at 16′ and 18′ in FIG. 2, which is a succeeding view to FIG. 1 presenting a second alternate depiction, such as instructed by the processor in response to any changing condition and which is reflected in an input signal sent to the individual rigid or flexible subset matrixes (again such as including thin film transistor components) configured within the lamp body.

In additional non-limiting embodiments, the individual matrixes can incorporate a thin film electroluminescent (TFFL) material for providing a transparent display. Other options include transparent LCD or OLED elements contained within individual matrixes and being illuminated in alternating representations in order to provide varying depictions viewable by the pedestrian or other driver.

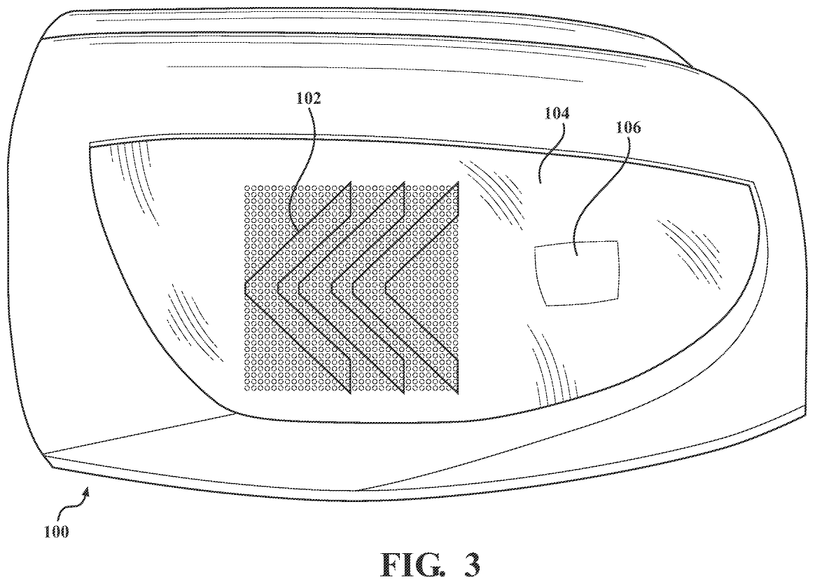

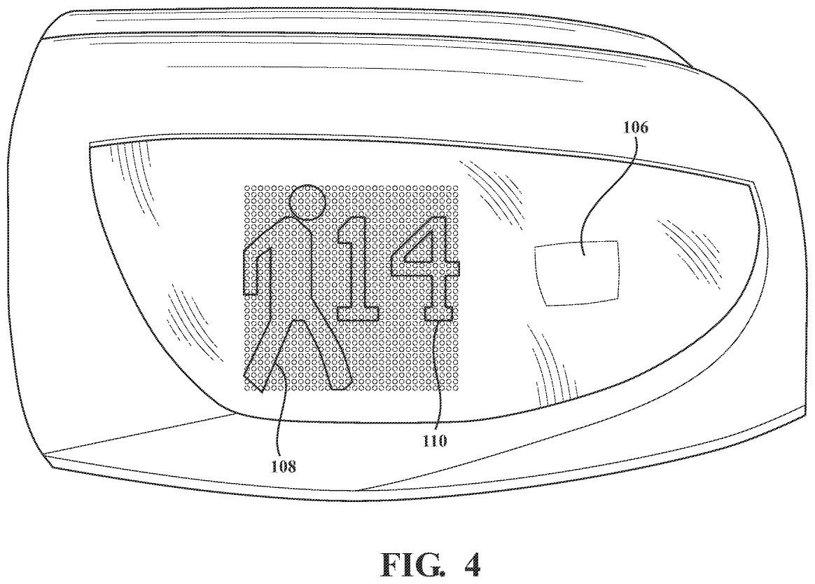

FIG. 3 is an illustration at 100 of a vehicle lamp according to a further configuration and presenting a given LED illuminated depiction 102, such as again incorporated into any rigid or flexible matrix substrate integrated into the housing behind an outer lens 104 and in combination with a main illuminating lamp 106. FIG. 4 is a succeeding view to FIG. 3 with the lamp depicting a pair of second LED generated representations, further at 108 and 110, which can result from the subset display 16, and which can be associated with a pedestrian crossing representation akin to a traffic walkway mounted signaling assembly.

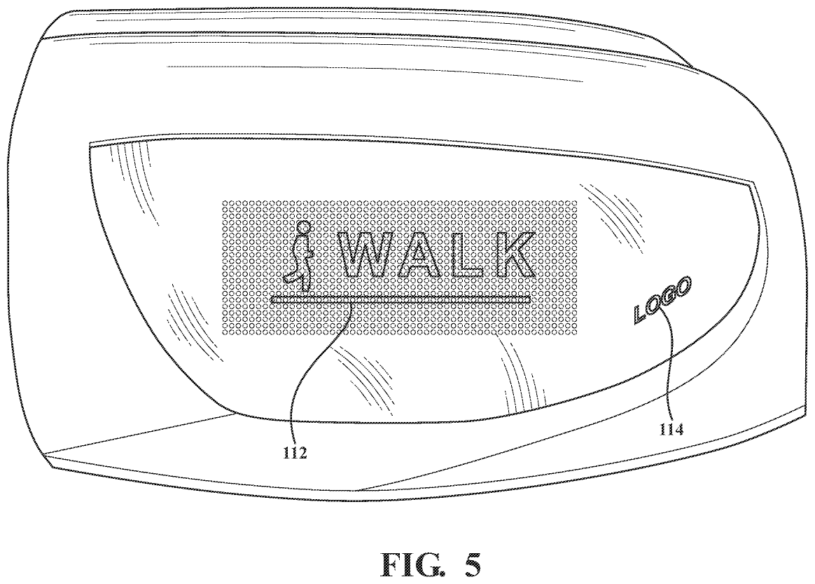

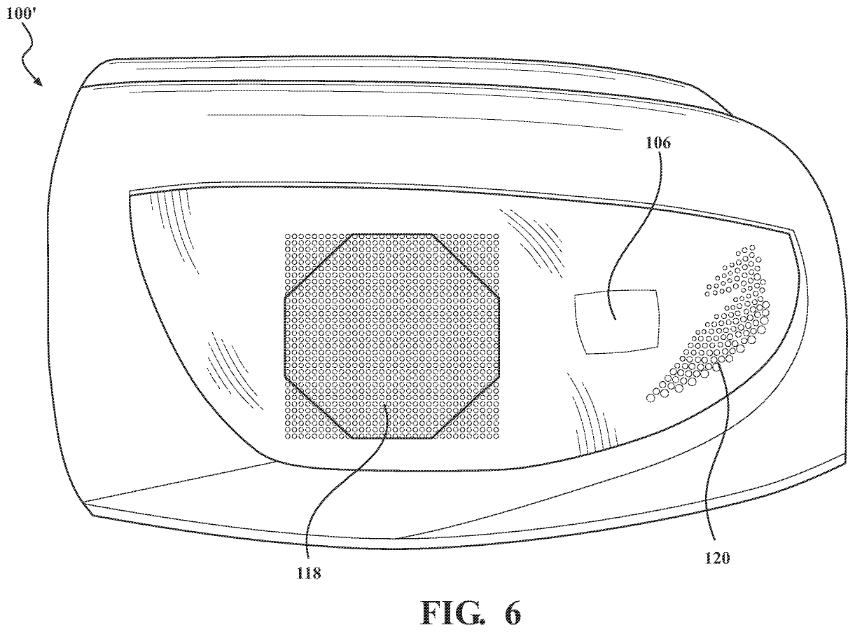

FIG. 5 is a further succeeding view of a lamp design similar to FIG. 3 according to a third varied LED generated depiction shown at 112 and in combination with any secondary identifying or commercial representation 114. FIG. 6 provides a pair of fourth LED depictions 118 and 120 of the lamp design of FIG. 3, and as further modified at 100′.

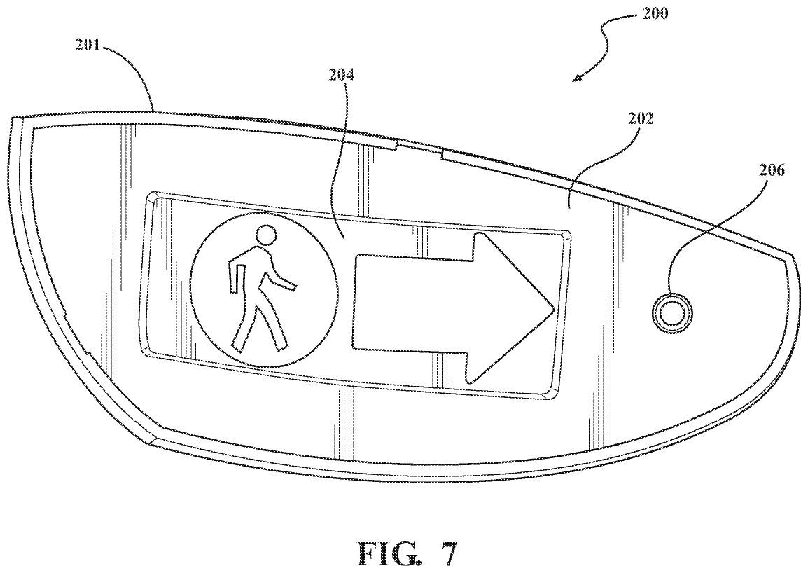

Finally, FIG. 7 provides an illustration similar to FIG. 1, of a further variant 200 of the pedestrian communication fog lamp according to the present invention. As with FIG. 1, the lamp assembly is incorporated into an outer housing body 201, with a forward face of the lamp assembly covered by an outer lens 202 which shields a main lamp illuminating portion 204 (such as a halogen or other high intensity illuminating source) for providing the primary fog lamp function. Also optionally provided behind the outer lens, and such as to either side of the main illuminating lamp 204, are one or more secondary illuminating elements in the form of either flexible or rigid subset displays (see such as shown at 206), and which is further capable of providing customized pedestrian notification representations in response to inputs from a processor component (see again FIG. 1) which can further illuminate the main lamp.

Advantages of the present invention include the ability to utilize an automotive grade matrix circuit design into an existing fog lamp packaging space for providing the pedestrian communication aspects, as well as low regulation and position of the fog lamp to provide for communicating safety information of any kind to pedestrians and/or other drivers. The present assembly can also be utilized in all types of vehicles, not limited to manned or unmanned, rideshare or otherwise.

Having described my invention, other and additional preferred embodiments will become apparent to those skilled in the art to which it pertains, and without deviating from the scope of the appended claims. The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

We claim:

1. A vehicle mounted pedestrian communication lamp, comprising:
a housing defining an inner package space for receiving a main illuminating component and at least one secondary illuminating component for providing variable depictions based upon a processor input; and
said secondary component further including at least one individual matrix display containing a plurality of illuminating elements.

2. The lamp of claim 1, said illuminating elements each further comprising any of LED, TFFL, transparent LCD or OLED displays.

3. The lamp of claim 1, said individual matrix display further comprising either of a rigid or flexible display.

4. The lamp of claim 3, said flexible display further comprising a thin film transistor display.

5. The lamp of claim 1, said secondary illuminating component further comprising a pair of secondary illuminating components provided on either side of said main illuminating component.

6. The lamp of claim 1, said main illuminating component further comprising a fog lamp.

7. The lamp of claim 1, further comprising said processor communicating with an external input via any of Bluetooth or Near Field Communication protocols.
